(19) United States
(12) Patent Application Publication
(10) Pub. No.: US 2014/0197245 A1
(43) Pub. Date: Jul. 17, 2014

(54) ARRANGEMENT AND METHOD FOR PREVENTING CARBON FORMATION IN SPRAY GUIDING STRUCTURES

(71) Applicant: Andrew E. Meyer, Harpers Ferry, WV (US)

(72) Inventor: Andrew E. Meyer, Harpers Ferry, WV (US)

(21) Appl. No.: 13/739,260

(22) Filed: Jan. 11, 2013

(51) Int. Cl. F02M 53/04

(52) U.S. Cl. CPC F02M 53/046
USPC 239/5; 239/132

(57) ABSTRACT

Method for preventing carbon build-up on fuel spray guiding surfaces proximate a nozzle of a fuel injector. Liquid fuel handling surfaces of the fuel injector can remain cool while providing very hot surfaces to burn off carbon particles before carbon deposits can build up and change the spray characteristics. In the method, a spray guiding structure guides the fuel spray after exiting from the fuel injector and a deflector member is arranged around the injector body. The spray guiding structure is thermally insulated from the fuel injector, and this thermal insulation enables the spray guiding structure to be heated to a temperature above about 900° F. to prevent build up of carbon thereon.

### FIELD OF THE INVENTION

The present invention relates generally to an arrangement and method for preventing carbon formation in spray guiding structures and more specifically to an arrangement and method for preventing carbon formation in spray guiding structures of fuel injectors. The present invention also relates generally to arrangements and methods for enabling improved heating of the spray medium of fuel injectors to aid vaporization and atomization of the spray, and/or for preventing cracking of the fuel during the heating process.

### BACKGROUND OF THE INVENTION

It is well known that surfaces in engines which operate above about 900° F. or below about 400° F. do not accumulate carbon. In the first case at temperatures above about 900° F., carbon accumulates, but is burned off. In the second case at temperatures below about 400° F., fuel and oil do not thermally decompose and carbon does not form.

Fuel injectors have historically operated in the cold region of the spectrum, i.e., below about 400° F., because there has been no commercially viable way to transition between cold and hot without plugging the location of transition since the fuel will decompose even in the absence of air.

A wide variety of fuel injectors have been disclosed previously. Some of these are described in:

U.S. Pat. No. 3,069,099 entitled “Fuel Injection nozzle and spray device” issued Dec. 18, 1962 to Graham;

U.S. Pat. No. 4,270,257 entitled “Method for manufacturing a fuel injection valve” issued Jun. 1, 981 to Kimata et al.;

U.S. Pat. No. 4,550,875 entitled “Electromagnetic unit fuel injector with piston assist solenoid actuated control valve” issued Nov. 5, 1985 to Teerman et al.;

U.S. Pat. No. 4,572,433 entitled “Electromagnetic unit fuel injector” issued Feb. 25, 1986 to Deckard;

U.S. Pat. No. 4,693,424 entitled “Poppet covered orifice fuel injection nozzle” issued Sep. 15, 1987 to Sczomak;

U.S. Pat. No. 4,750,675 entitled “Damped opening poppet covered orifice fuel injection nozzle” issued Jun. 14, 1988 to Sczomak;

U.S. Pat. No. 4,813,610 entitled “Gasoline injector for an internal combustion engine” issued Mar. 21, 1989 to Renowden;

U.S. Pat. No. 4,852,853 entitled “Pressure balance type solenoid controlled valve” issued Aug. 1, 1989 to Toshio et al.;

U.S. Pat. No. 4,932,591 entitled “Pulverizer, fluid” issued Jun. 12, 1990 to Cruz;

U.S. Pat. No. 5,088,467 entitled “Electromagnetic injection valve” issued Feb. 18, 1992 to Mesenich;

U.S. Pat. No. 5,191,867 entitled “Hydraulically-actuated electronically-controlled unit injector fuel system having variable control of actuating fluid pressure” issued Mar. 9, 1993 to Glassey;

U.S. Pat. No. 5,551,638 entitled “Valve member for fuel injection nozzles” issued Sep. 3, 1996 to Caley;

U.S. Pat. No. 5,833,142 entitled “Fuel injector nozzles” issued Nov. 10, 1998 to Caley;

U.S. Pat. No. 5,979,803 entitled “Fuel injector with pressure balanced needle valve” issued Nov. 9, 1999 to Peters et al.;

U.S. Pat. No. 6,055,948 entitled “Internal combustion engine control system” issued May 2, 2000 to Shiraishi et al.;

U.S. Pat. No. 6,247,450 entitled “Electronic controlled diesel fuel injection system” issued Jun. 19, 2001 to Jiang;

U.S. Pat. No. 6,435,429 entitled “Fuel injection valve” issued Aug. 20, 2002 to Eichendorf et al.;

U.S. Pat. No. 6,446,597 entitled “Fuel delivery and ignition system for operation of energy conversion systems” issued Sep. 10, 2002 to McAlister;

U.S. Pat. No. 6,568,080 entitled “Air assist fuel injectors and method of assembling air assist fuel injectors” issued May 27, 2003 to Kimmel et al.;

U.S. Pat. No. 6,708,905 entitled “Supersonic injector for gaseous fuel engine” issued Mar. 23, 2004 to Borissov et al.;

U.S. Pat. No. 6,725,838 entitled “Fuel injector having dual mode capabilities and engine using same” issued Apr. 27, 2004 to Shafer et al.;

U.S. Pat. No. 6,755,175 entitled “Direct injection of fuels in internal combustion engines” issued Jun. 29, 2004 to Mckay et al.;

U.S. Pat. No. 6,923,387 entitled “Deposit control in fuel injector nozzles” issued Aug. 2, 2005 to Carlisle et al.;

U.S. Pat. No. 6,978,942 entitled “Shockwave injector nozzle” issued Dec. 27, 2005 to Murdoch;

U.S. Pat. No. 7,083,126 entitled “Fuel injection arrangement” issued Aug. 1, 2006 to Lehtonen et al.;

U.S. Pat. No. 7,137,571 entitled Fuel injector nozzles” issued Dec. 21, 2006 to Caley et al.; U.S. Pat. No. 7,350,539 entitled “Electromagnetic controlled fuel injection apparatus with poppet valve” issued Apr. 1, 2008 to Kaneko;

U.S. Pat. No. 7,353,806 entitled “Fuel injector with pressure balancing valve” issued Apr. 8, 2008 to Gant;

U.S. Pat. No. 7,387,289 entitled “Method and apparatus for driving a solenoid proportional control valve utilized for flow rate control” issued Jun. 17, 2008 to Kubota et al.;

U.S. Pat. No. 7,942,349 entitled “Fuel injector” issued May 17, 2011 to Meyer; and

U.S. Pat. No. 7,740,002 entitled “Fuel injector” issued Jun. 22, 2010 to Zeng et al.

All of the foregoing patents are incorporated by reference herein.

Of particular interest, U.S. Pat. No. 7,942,349, the inventor's earlier patent, discloses a fuel injector body having a fuel chamber and a valve seat around a fuel outlet. A valve body is positioned at the valve seat and a valve stem extends through the fuel outlet and fuel chamber. Engagement (disengagement) of valve body and valve seat closes (opens) the injector. The injector body or the valve body may include one or more spray-shaping surfaces arranged to direct the fuel sprayed from the fuel outlet. The spray-shaping surfaces are arranged on the injector body around all or part of the valve seat, or on the valve body around all or part of a valve-seat-engaging portion of the valve body. The spray-shaping surfaces are thus formed on the injector body or the valve body.

### OBJECTS AND SUMMARY OF THE INVENTION

It is an object of the present invention to provide an arrangement and method for improving operation and/or use of spray guiding structures of, for example, fuel injectors.

A fuel injection arrangement for an engine in accordance with the invention includes a fuel injector having an injector body and a valve body and that is configured to inject fuel in spray form into a combustion chamber in the engine, a spray guiding structure that guides the fuel spray after exiting from the fuel injector, and a deflector member arranged around the injector body. The spray guiding structure is thermally insulated from the fuel injector to enable the spray guiding structure to be heated to a temperature above about 900° F. and thereby prevent build up of carbon on the spray guiding structure.

A method for improving use of a fuel injector for an engine in accordance with the invention includes interposing a deflector member between the fuel injector and the engine, guiding the fuel spray after exiting from the fuel injector by means of a spray guiding structure supported by the deflector member, and providing thermal insulation to insulate the spray guiding structure from the fuel injector. As in the arrangement, the thermal insulation of the spray guiding structure from the fuel injector enables the spray guiding structure to be heated to a temperature above about 900° F. to prevent build up of carbon on the spray guiding structure.

### BRIEF DESCRIPTION OF THE DRAWINGS

The invention may best be understood by reference to the following detailed description of an illustrative embodiment when read in conjunction with the accompanying drawings, wherein:

FIG. 1 is a cross-sectional view of one embodiment of an outwardly opening poppet fuel injector placed in an engine in accordance with the invention.

FIG. 2 is a cross sectional representation of a conventional multi-orifice injector placed in an engine in accordance with the invention.

FIG. 3 is a cross-sectional view of an embodiment of a fuel injector in accordance with the invention including electric heating elements.

FIG. 4 is a cross-sectional view of an embodiment of a fuel injector in accordance with the invention including an insulating material fastened to the injector, and is an alternative example of how the injector could be made.

### DETAILED DESCRIPTION OF THE INVENTION

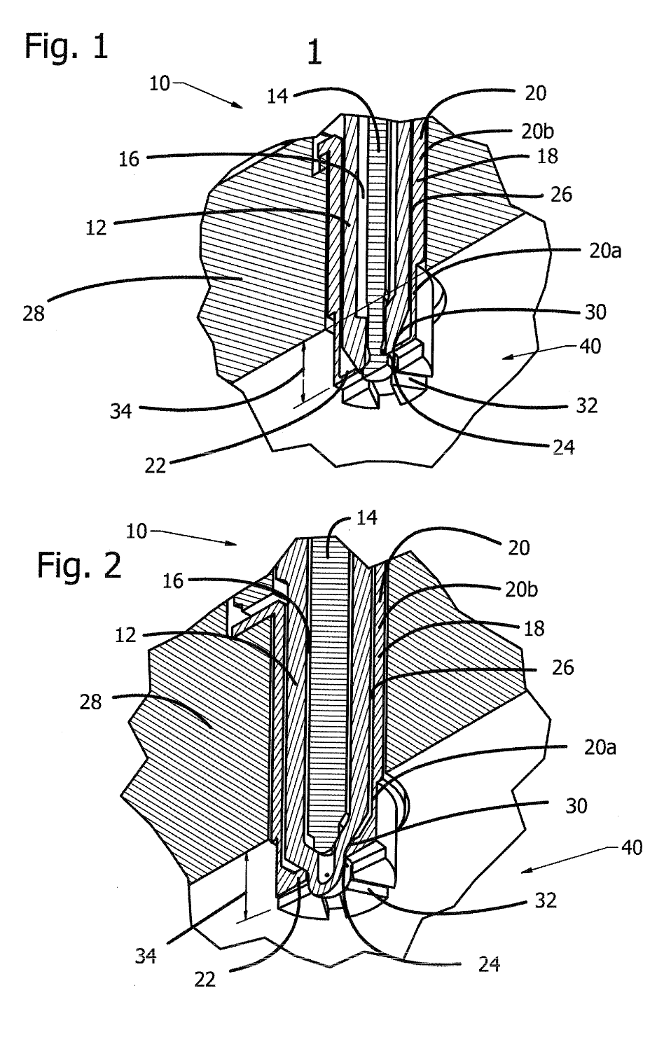

As shown in FIG. 1, a fuel injector 10 in accordance with the invention includes an injector body 12 defining an interior cavity in which a poppet or fuel metering valve body 14 reciprocates. A fuel passage 16 is defined between an inner surface of the injector body 12 and an outer surface of the valve body 14. These features are mostly conventional for a poppet style fuel injector 10 and shown to enable explanation of the invention. Thus, the invention is not limited to any particular form of injector body 12 and valve body 14 and is applicable to fuel injectors with other forms and shapes of these components, such as illustrated in FIG. 2. The manner in which the injector body 12 and valve body 14 cooperate to provide the known functions of a fuel injector are known to those skilled in the art, and described, for example, in U.S. Pat. No. 7,942,349.

In accordance with the invention, a deflector member 18 is arranged around the injector body 12, which deflector member 18 is also considered a heat shield. Deflector member 18 may be designed to completely surround the injector body 12, i.e., it defines a cylindrical cavity in which the injector body 12, and valve body 14 therein, is placed. The deflector member 18 includes a substantially cylindrical side wall 20 and a lower, end wall 22 having an aperture 24 through which the fuel from the fuel injector 10 is sprayed. End wall 22 is appropriately termed a lower end wall when the fuel injector 10 has the configuration shown in FIG. 1 but when the fuel injector 10 has other configurations, the lower end wall 22 is not required to be at a lower edge of the cylindrical wall 20.

An air gap 26 may be formed between the inner surface of the cylindrical side wall 20 of the deflector member 18 and the outer surface of the injector body 12. The air gap 26 functions as insulation, and as an alternative to air, an insulating material may be arranged in this gap.

A lower portion 20a of the cylindrical side wall 20 has a smaller thickness than an upper portion 20b and serves as a heat control wall. The transition area between the lower and upper portions 20a, 20b may be at or proximate the edge of an engine 28 in which the fuel injector 10 is housed.

The deflector member 18 is constructed so that the surfaces defining the aperture 24 in the lower end wall 22 bear against outer surfaces of the injector body 12. This contact area 30 between the injector body 12 and the deflector member 18 enables alignment of the injector body 12 when engaged with the deflector member 18 as well as sealing of the air gap 26. Further, an upper portion of the deflector member 18 is constructed to enable secure coupling to the engine 28 (as shown in the upper, left portion of FIG. 1).

Deflector member 18 provides several functions. First, the deflector member 18 serves as a heat shield to prevent heat transmission between the fuel injector 10 and the combustion chamber 40 into which the fuel injector 10 extends. Second, the deflector member 18 supports spray guiding structure 32 that guides the fuel being sprayed from the fuel injector 10.

The spray guiding structure 32 is arranged on the lower surface of the lower end wall 22 and comprises spray guiding surfaces that modify the spray coming out of the fuel injector 10. The spray guiding surfaces may have any of the forms disclosed in U.S. Pat. No. 7,942,349, wherein they are alternatively referred to as spray shaping surfaces. The spray guiding structure 32 may be integral or monolithic with the deflector member 18 or a separate component.

The spray guiding structure 32 is arranged around the circumference of the lower end wall 22, i.e., around the circumference of the injector body 12 and therefore inherently around the circumference of the valve body 14 since a portion of the injector body 12 interposes between the surface of the lower end wall 22 defining the aperture 24 and the valve body 14 in view of contact between the lower end wall 22 and the injector body 12. Thus, the spray guiding structure 32 has an annular form. The spray guiding structure 32 does not need to be continuous around the circumference of the injector body 12 or valve body 14.

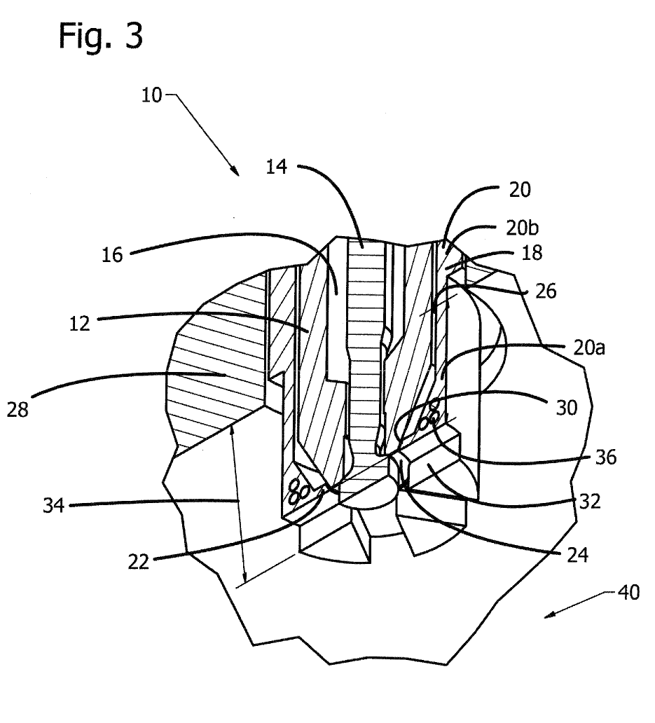

The spray guiding structure 32 and specifically the spray guiding surfaces, are insulated from the injector fuel passages and valve seat. This is done because they are exposed to the combustion chamber 40 and thus heated to a temperature at which carbon deposits burn off (typically above 1000° F.). In the exemplary case of FIG. 1, a minimal area of un-insulated contact occurs between the deflector 18 and the injector body 12 in order to provide good alignment between the two structures. Instead of or in addition to the heat being supplied by exposure to medium from the combustion chamber in the engine 28, heat may also be supplied by auxiliary heating as for example by electric heat or catalytically augmented chemical reactions. The electrically heated case is shown in FIG. 3; the catalytically heated case is not shown.

The material providing thermal insulation between the spray guiding structure 32 and the fuel injector 10 may be monolithic or integral with the injector body 12 if a material with adequate properties can be found, for example, an engineered ceramic may provide insulation and adequate strength. In this embodiment, at least a portion of the injector body 12, namely that portion alongside the lower end wall 22 of the deflector member 18 on which the spray guiding structure 32 is arranged, is formed as an insulative member. Specific insulating material may not be necessary because of the small contact area between the deflector member 18 and the injector body 12.

As an alternative, the insulating material may be arranged as a separate element between the engine 28 and the deflector member 18, or between the injector body 12 and the deflector member 18, or monolithic or integral with the deflector member 18, or in any other way which provides thermally isolated surfaces which operate at high temperatures to guide the spray. Generally then, the spray guiding structure 32, whether formed on the deflector member 18 or separate therefrom, is thermally insulated from the fuel injector 10.

In the embodiment shown in FIG. 1, the fuel comes out from the fuel injector 10 in a sheet between the injector body 12 and the valve body 14. The fuel spray impacts the spray guiding structure 32, bounces off the spray guiding structure 32 and is redirected to a desirable spatial location in the engine 28. As such, an important advantage of the invention is obtained in that the spray guiding structure 32 does not become involved with the fuel stream until after the fuel has exited the fuel injector 10, i.e., exited from the fuel passage 16 between the injector body 12 and the valve body 14. At this stage, the fuel is, by virtue of the operation of the valve body 14 relative to the injector body 12, starting to break up into droplets and mix with air in order to burn.

Since the fuel injector 10 operates at temperatures below about 400° F., no carbon builds up on the internal fuel passages 16. Since the deflector member 18 operates at temperatures above 900° F., no carbon builds up on the deflector member 18. The temperature of the heat deflector 18 can be controlled by any one or more of the following parameters: 1) the degree to which the fuel injector 10 and surround deflector member 18 and spray guiding structure 32 penetrates or projects into the combustion chamber of the engine 28 (designated by reference numeral 34), 2) the characteristics of the contact area 30 between the injector body 12 and the deflector member 18, and 3) the characteristics, such as the length and thickness, of the cylindrical side wall 20 and lower end wall 22 of the deflector member 18, 4) the clearance between the deflector member 18 and the engine 28, and 5) any additional or auxiliary heat input.

With the foregoing structure, it is possible to make the spray guiding surface or other spray guiding structure 32 operate at hot temperature or sufficiently high temperatures to burn off any carbon build up. A similar technique has been used for many years in spark plugs, where any build up of carbon causes a short circuit between the plug electrodes and prevents spark formation. Various heat range spark plugs have been developed and reliability for hundreds of hours has been provided.

Furthermore, the deflector member 18 in combination with the spray guiding structure 32, when placed around a fuel injector 10 enables carbon formation on the spray guiding structure 32 to be prevented in view of the capability of increasing the heat at the spray guiding structure 32.

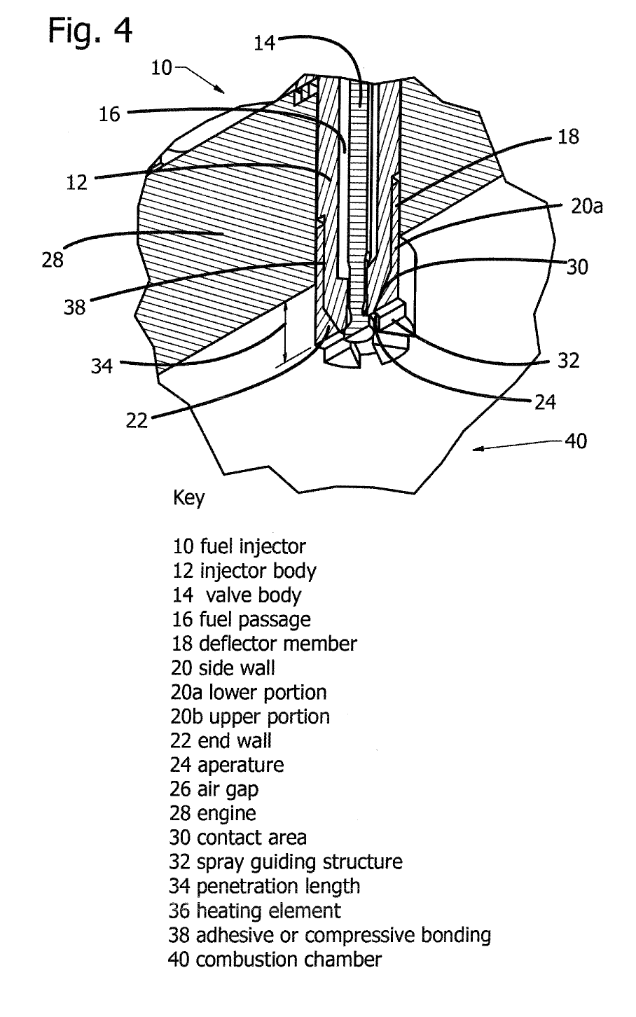

As additional description of the alternative embodiments shown in FIGS. 2-4, in FIG. 2, the injector body 12 includes a closed tip and several orifices around the tip. These orifices provide communication between the fuel passage 16 and the combustion chamber 40. In FIG. 3, the lower portion 20a of the cylindrical side wall 20 includes an auxiliary heating system, represented by the conduits 36 through which a heating media can be directed. In FIG. 4, the deflector member 18, serving partly as an insulating member, is fastened to the injector body 12 using, for example, adhesive or compressive bonding. Also, a portion of the injector body 12 that is not surrounded by the deflector member 18 directly faces the cylindrical cavity in the engine 28 (in contrast to the embodiment shown in FIG. 1 wherein the deflector member 18 interposes completely between the injector body 12 and the cylindrical cavity of the engine 28).

As used herein, “sufficiently high” and “hot” temperatures mean temperatures hot enough to keep carbon build up from forming.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims.

I claim:

1. A fuel injection arrangement for an engine, comprising;
a fuel injector having an injector body and a valve body and configured to inject fuel in spray form into a combustion chamber in the engine;
a spray guiding structure that guides the fuel spray after exiting from said fuel injector; and
a deflector member arranged around at least a part of said injector body,
said spray guiding structure being thermally insulated from said fuel injector,
whereby the thermal insulation of said spray guiding structure from said fuel injector enables said spray guiding structure to be heated to a temperature above about 900° F. to prevent build up of carbon on said spray guiding structure.

2. The arrangement of claim 1, wherein said deflector member comprises a cylindrical cavity, said injector body being arranged in said cavity defined by said deflector member.

3. The arrangement of claim 1, wherein said deflector member comprises a substantially cylindrical side wall and an end wall having an aperture through which the fuel spray from said fuel injector passes.

4. The arrangement of claim 3, wherein said cylindrical side wall of said deflector member is spaced from said injector body to define a gap between an inner surface of said cylindrical side wall and an outer surface of said injector body, said gap containing an insulating medium.

5. The arrangement of claim 4, wherein surfaces of said end wall defining said aperture bear against outer surfaces of said injector body to form a contact area between said injector body and said deflector member to align said injector body with said deflector member and seal said gap.

6. The arrangement of claim 1, wherein said deflector member is made of thermally insulative material to constitute a heat shield.

7. The arrangement of claim 1, wherein said spray guiding structure is formed on said deflector member.

8. The arrangement of claim 1, wherein said spray guiding structure comprises spray guiding surfaces that modify the fuel spray after exiting from said fuel injector.

9. The arrangement of claim 1, wherein said spray guiding structure is thermally insulated from said fuel injector by thermal insulation material monolithic or integral with said injector body.

10. The arrangement of claim 1, wherein said spray guiding structure comprises spray guiding surfaces arranged around a circumference of said injector body.

11. The arrangement of claim 1, wherein said spray guiding structure comprises spray guiding surfaces arranged around a circumference of said valve body.

12. The arrangement of claim 1, further comprising an auxiliary heating system arranged in connection with said deflector member proximate said spray guiding structure and configured to heat said spray guiding structure.

13. The arrangement of claim 1, wherein said deflector member is interposed entirely between said injector body and the engine.

14. The arrangement of claim 1, wherein said deflector member surrounds only part of said injector body.

15. The arrangement of claim 1, wherein said deflector member constitutes an insulating member and is connected to said injector body using adhesive or compressive bonding.

16. A method for improving use of a fuel injector for an engine, the fuel injector being configured to inject fuel in spray form into a combustion chamber in the engine, the method comprising:
interposing a deflector member between at least part of the fuel injector and the engine,
guiding the fuel spray after exiting from the fuel injector by means of a spray guiding structure supported by the deflector member; and
providing thermal insulation to insulate the spray guiding structure from the fuel injector,
whereby the thermal insulation of the spray guiding structure from the fuel injector enables the spray guiding structure to be heated to a temperature above about 900° F. to prevent build up of carbon on the spray guiding structure.

17. The method of claim 16, wherein the spray guiding structure is formed on the deflector member.

18. The method of claim 16, further comprising defining spray guiding surfaces on the spray guiding structure that modify the fuel spray after exiting from the fuel injector.

19. The method of claim 16, further comprising arranging thermal insulation material monolithic or integral with the injector body to provide the thermal insulation that insulates the spray guiding structure from the fuel injector.

20. The method of claim 16, further comprising heating the spray guiding structure by means of an auxiliary heating system arranged in connection with the deflector member proximate the spray guiding structure.
